(19) United States
(12) Patent Application Publication
(10) Pub. No.: US 2013/0009889 A1
(43) Pub. Date: Jan. 10, 2013

(54) METHOD FOR EDITING INPUT INTERFACE AND ELECTRONIC DEVICE USING THE SAME

(75) Inventor: MING-YUAN WENG, Teipei City (TW)

(73) Assignee: COMPAL COMMUNICATIONS, INC., Taipei City (TW)

(21) Appl. No.: 13/523,775

(22) Filed: Jun. 14, 2012

(30) Foreign Application Priority Data
Jul. 4, 2011 (TW) 100123582

(51) Int. Cl. G06F 3/041

(52) U.S. Cl. 345/173

(57) ABSTRACT

A method for editing an input interface comprises steps of: providing a selection event to select an input unit displayed at a first position; providing a moving event to move the input unit to a second position; setting an input interface for the touch module according to information of the input unit displayed at the second position; and displaying the input interface on the display module. An electronic apparatus using the above method is also disclosed in the invention.

### CROSS REFERENCE TO RELATED APPLICATIONS

This Non-provisional application claims priority under 35 U.S.C. §119(a) on Patent Application No(s). 100123582 filed in Taiwan, Republic of China on Jul. 4, 2011, the entire contents of which are hereby incorporated by reference.

### BACKGROUND OF THE INVENTION

1. Field of Invention

The invention relates to a method for editing an input interface, in particular, to the method for editing an input interface applied to an electronic apparatus.

2. Related Art

At the present age, most of the electronic products are equipped with data input function that is commonly performed with a keyboard to input characters, symbols, or other contents. For the old-type keyboards, all keys are individually manufactured and arranged orderly on a main body without capacity of variation. Besides, the old-type keyboards make a lot of noises during keying, and the prints on the keys will gradually vanish after being used for a long time, thereby causing the inconvenience to operators.

Nowadays, the touch input technology has come out to replace the old-type keyboard and can eliminate the drawbacks of the conventional keyboard. For the touch input technology, an input interface is displayed and arranged on the screen by software, and the operator can touch the input interface to input data without the physical buttons.

With the progress of technologies, the touch-type keyboard has been widely used in the tablet computers and smart phones. However, the touch-type keyboards in the market still follow the conventional arrangement of the old-type keyboard. Even the so-called customization touch-type keyboard is designed only for a specific purpose, such as for the Chinese input or other languages, or for a specific requirement such as leaving out the numeral keys.

It can be seen that the conventional touch-type keyboards are manufactured to a stationary model and can provide, if any, two arrangement options for the operator. Nevertheless, the conventional touch-type keyboard can not be adjusted in position or number of the keys. That means the conventional touch-type keyboard is not real customization. Besides, when the touch-type keyboard is displayed on the smaller phone or tablet computer, the operator is difficult to identify the contents of the input interface and not easy to input data, especially for the bigger-hand operators.

For the all above problems, if a method for editing an input interface and an electronic apparatus using the same can not be provided, the advantage will not be shown up that the input interface can be designed without limitation by the software. Besides, with the more compact designed electronic products, the key size is more reduced, and that will cause more inconvenience to the operators.

Therefore, it is an important subject to provide a method for editing an input interface and an electronic apparatus using the same that can allow the operators to rearrange the keys of the input interface to fit their own desires and requirements so as to enhance the operational friendliness and convenience.

### SUMMARY OF THE INVENTION

In view of the foregoing subject, an object of the invention is to provide a method for editing an input interface and an electronic apparatus using the same that can allow the operators to rearrange the keys of the input interface to fit their own desires and requirements so as to enhance the operational friendliness and convenience.

To achieve the above objective, the present invention discloses a method for editing an input interface, which comprises steps of: providing a selection event to select an input unit displayed at a first position; providing a moving event to move the input unit to a second position; setting an input interface for the touch module according to information of the input unit displayed at the second position; and displaying the input interface on the display module.

In one embodiment, the first position and the second position are displayed on the display module of the electronic apparatus or on another display module.

In one embodiment, the first position is displayed on another display module, and the second position is displayed on the display module of the electronic apparatus.

In one embodiment, the display module is an e-paper, a light-emitting diode (LED) display module, a thin-film transistor (TFT) display module, or a liquid crystal (LC) display module.

In one embodiment, the touch module is stacked on the display module.

In one embodiment, the input unit is a key.

In one embodiment, the method for editing an input interface further comprises a step of: providing an adjusting event to adjust the input unit.

In one embodiment, the method for editing an input interface further comprises a step of: displaying an image data and/or an audiovisual data on the display module of the electronic apparatus.

To achieve the above objective, the present invention discloses an electronic apparatus, which comprises a touch module and a display module. A selection event is provided to select an input unit displayed at a first position. A moving event is provided to move the input unit to a second position. An input interface for the touch module is set and displayed on the display module according to information of the input unit displayed at the second position.

In one embodiment, the first position and the second position are displayed on the display module of the electronic apparatus or on another display module.

In one embodiment, the first position is displayed on another display module, and the second position is displayed on the display module of the electronic apparatus.

In one embodiment, the display module is an e-paper, a light-emitting diode (LED) display module, a thin-film transistor (TFT) display module, or a liquid crystal (LC) display module.

In one embodiment, the touch module is stacked on the display module.

In one embodiment, the input unit is a key.

In one embodiment, an adjusting event is provided to adjust the input unit.

In one embodiment, the display module displays an image data and/or an audiovisual data.

As mentioned above, for the method for editing an input interface and the electronic apparatus using the same of the invention, the input unit can be moved from a first position to a second position, so that the operator can freely edit the arrangement of the input interface to fit the own desires or specific operational requirement. Besides, the first position can be not only on the electronic apparatus, but also on another display module, and that can also make the result that the input unit is added to the input interface or removed from the input interface.

According to the method for editing an input interface and the electronic apparatus using the same of the invention, the position of every input unit can be adjusted. The more precious point is that the specific input unit can be added or removed, according to the requirement, by using the unit database. Hence, the seldom used input unit can be replaced by the commonly used one so that the limited space of the input interface can be efficiently utilized. By repeating the operation many times, the selected input units can compose an input interface that fits the operator's habit or requirement and can be stored in the electronic apparatus. Therefore, the invention can achieve the advantage of really customization by operators.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view showing the appearance of an electronic apparatus of a first embodiment of the invention.

FIG. 2A is a schematic view showing an image displayed by the display module of the electronic apparatus of FIG. 1;

FIG. 2B is a schematic view showing the input unit shown in FIG. 2A is moved to the second position;

FIG. 2C is a schematic view showing the editing result of the input interface and the input units thereof in FIG. 2A;

FIG. 3 is a schematic view showing the input unit, treated by an adjusting event, of the input interface according to the first embodiment of the invention;

FIG. 4 is a schematic view showing an image displayed by the display module of the electronic apparatus according to a second embodiment of the invention;

FIG. 5 is a schematic view showing the appearance of the electronic apparatus according to a third embodiment of the invention;

FIG. 6 is a schematic view showing the appearance of the electronic apparatus according a fourth embodiment of the invention; and

FIG. 7 is a flow chart describing a method, according to a first embodiment of the invention, for editing an input interface.

### DETAILED DESCRIPTION OF THE INVENTION

The present invention will be apparent from the following detailed description, which proceeds with reference to the accompanying drawings, wherein the same references relate to the same elements.

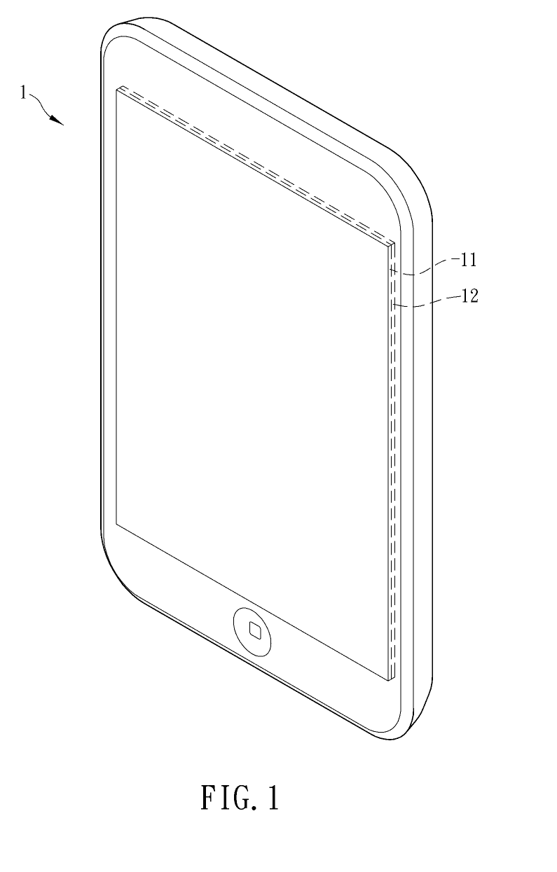

FIG. 1 is a schematic view of the appearance of an electronic apparatus according to a first embodiment of the invention. The electronic apparatus 1 of the embodiment includes a touch module 11 and a display module 12. Thereinafter, various aspects of the components of the electronic apparatus 1 within the scope of the invention are described first, and the operational procedure follows.

In the embodiment, the electronic apparatus 1 can be, for example but not limited to, a tablet computer, a smart phone, a personal digital assistant (PDA), or a navigator with Global Positioning System (GPS). The touch module can be a capacitive type touch module, a resistive type touch module, an optical type touch module, or an acoustic wave type touch module. The display module 12 can be an e-paper, a light-emitting diode (LED) display module, a thin-film transistor (TFT) display module, or a liquid crystal (LC) display module. Herein, the electronic apparatus 1 is a smart phone, the touch module 11 is a capacitive type touch module, and the display module 12 is an e-paper, for example. Obviously, not limited to the above case, the electronic apparatus, the touch module, and the display module of the invention can be any of the combinations of all the above-mentioned components. Notably, because the display module 12 is an e-paper, featured by bistable states, it can preserve the image without the power supply. So, the e-paper is more suitable to simulate a physical keyboard. Besides, this kind of display module 12 needs the additional power supply only when the input interface is edited, so the power consumption can be reduced. In the embodiment, the touch module 11 is stacked on the display module 12; otherwise, the display module 12 can be stacked on the touch module 11.

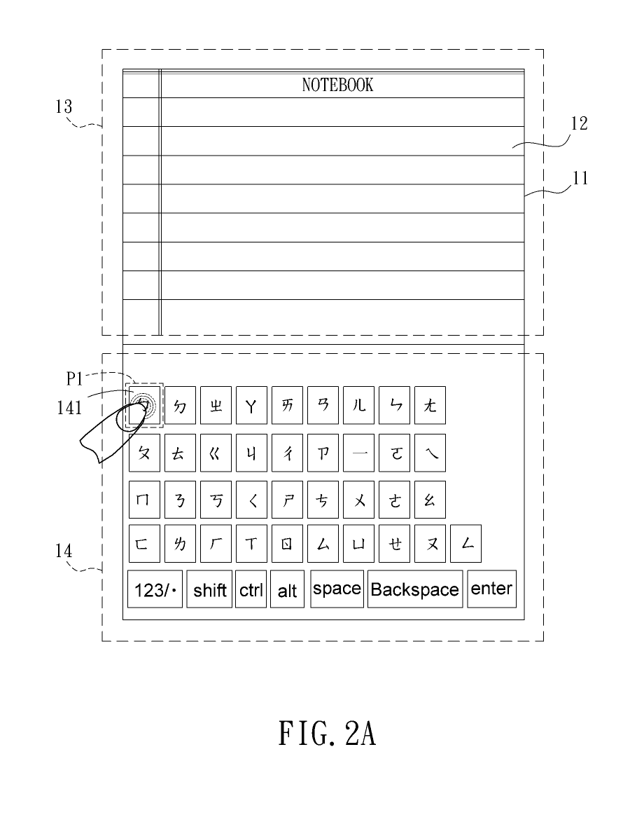

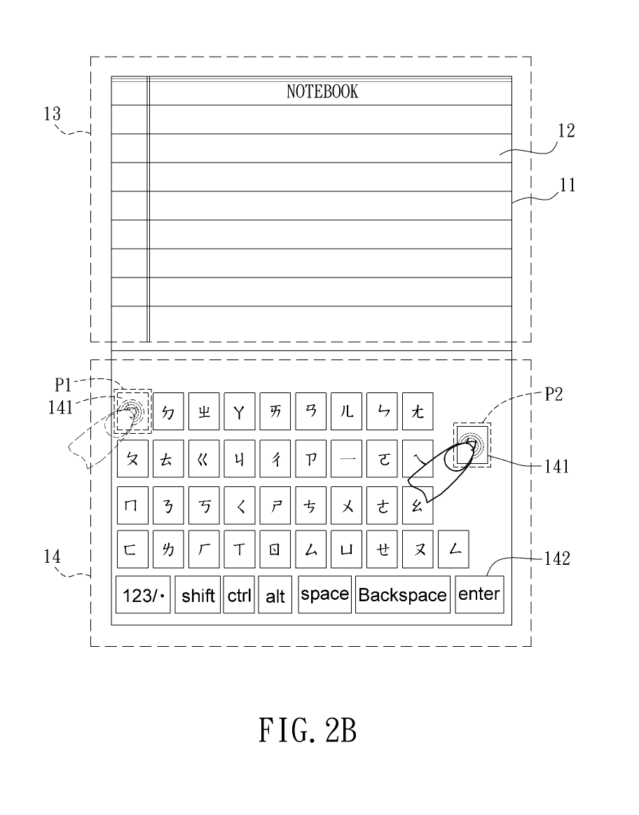

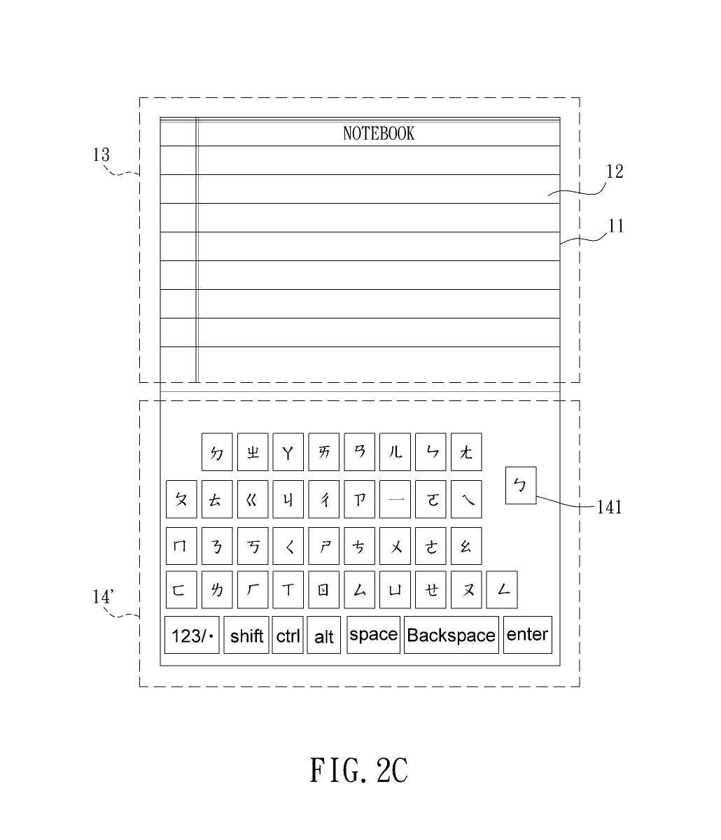

FIG. 2A is a schematic view showing an image displayed by the display module of the electronic apparatus of FIG. 1. As shown in FIG. 2A, the display module 12 displays a display area 13 and an input interface 14. The display area 13 is mainly used to show the input information input by the operator. Herein, the display area 13 serves as a notebook function. The input interface 14 includes a plurality of input units provided to the operator for inputting information. For example, the input interface 14 can serve as a virtual keyboard, and the input units can be the keys to show the information, such as English letters, phonetic alphabet, or numerals. The amount of the input units of the input interface is unlimited, which can be 44, 103, 109, or any number. The below illustration is continued by taking the input unit 141 as an example.

When the operator wants to edit the arrangement of the input interface 14, a selection event can be provided to select the input unit 141 which is displayed at a first position P1. The operator can touch the input unit 141 displayed at the first position P1 by a finger or a tool such as a stylus. Herein, the operator touches the input unit 141 by a finger in the embodiment. The selection event can be conducted in various aspects. For example, the first position P1 or the input unit 141 is touched once; or, the first position P1 or the input unit 141 is touched for a certain time; or, the first position P1 or the input unit 141 is multi-touched; or, a physical or a virtual control button is triggered to launch the editing program of the input interface 14, and then the first position P1 or the input unit 141 is touched in any kind of the above-mentioned aspects. As for the timing of editing the input interface 14, it can be during the running of the editing program, or during the information input.

After the input unit 141 is selected, a moving event can be provided to move the input unit 141 to a second position. FIG. 2B is a schematic view showing the input unit 141 of FIG. 2A is moved to the second position. As shown in FIG. 2B, in the moving event, the input unit is moved or dragged to the second position P2 in which the touch module 11 is continuously touched. The moving event can be provided by other way. For example, the input unit 141 is touched and presents a marked state such as shaking to show it has been selected, and the second position P2 can be touched in a manner of the selection event, such as one click or a certain-time touch, to designate the position to which the input unit 141 is moved.

Of course, the selection of the first position P1 and/or the second position P2 can be completed by touching once or many times, such as twice.

After the input unit 141 is moved to the second position P2, a confirmation event can be provided to finish the move of the input unit 141. Various ways can be used to provide the confirmation event, and some cases are illustrated as below for example. The confirmation event can be provided by touching another input unit 142 that is set to perform the confirmation function; or, the confirmation event can be provided by touching the second position P2 once the moving event has been done; or, the confirmation event can be provided by not touching the touch module 11 for a certain time once the moving event has been done.

Although only the input unit 141 is instanced to illustrate the adjusting procedure, in practice, other input units can be sequentially or simultaneously taken into the selection event, moving event, and/or the input event for freely editing the arrangement of the input interface 14. FIG. 2C is a schematic view showing the editing result of the input interface and the input units thereof in FIG. 2A. In the embodiment, an input interface 14′ is set for the touch module 11 according to information of the input unit 141 displayed at the second position P2, and displayed on the display module 12 as shown in FIG. 2C. Besides, the information of the input unit 141 displayed at the second position P2 can be stored in the electronic apparatus to serve as a predetermined or an optional input interface.

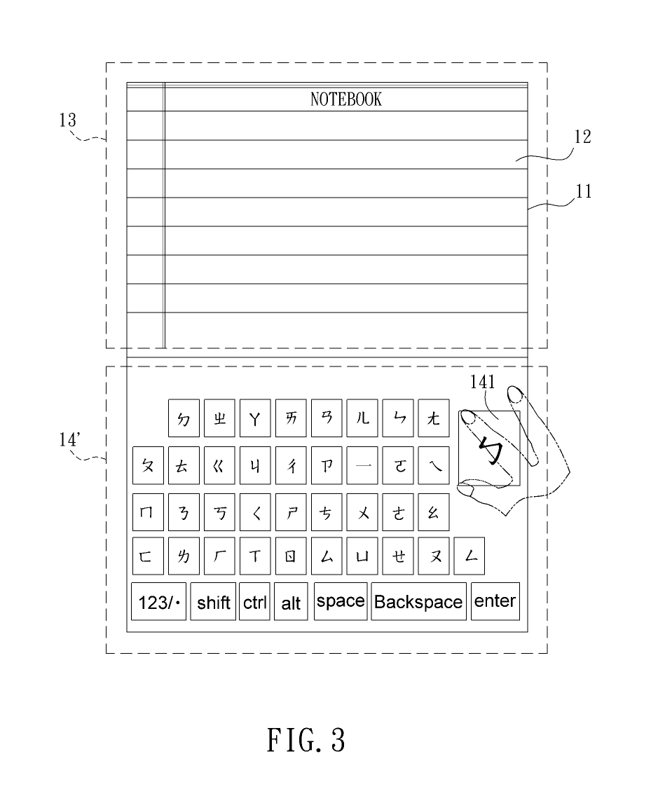

FIG. 3 is a schematic view showing the input unit, treated by an adjusting event, of the input interface according to the first embodiment of the invention. As shown in FIG. 3, in the embodiment, the operator can provide an adjusting event to rearrange the position or adjust the size, color, mark, or other features of the input unit 141. As shown in FIG. 3, after the moving event, the input unit 141 can be adjusted in size when the operator multi-touches the input interface 14′ and draws his fingers outward or inward. Obviously, the adjusting event is not limited to the finger motion as mentioned above, and in other embodiment, the finger motion can be, for example, one-touch one-way sliding, multi-touch one-way sliding, multi-touch parallel drawing outward, multi-touch drawing inward, or multi-touch rotation. In practice, the multi-touch parallel drawing outward means the operator's forefinger and thumb contact the input unit 141 at the same time, and the two fingers are gradually drawn outward so as to proportionally enlarge the input unit 141. The multi-touch one-way sliding means the operator's two fingers contact the input unit 141 at the same time, and one of the fingers keeps stationary and the other is drawn according to one direction so as to enlarge or narrow the input unit 141 according to the direction. Besides, the orientation of the input unit 141 can be also adjusted, and for example, it can be rotated to any angle by the multi-touch rotation.

By the all operations as mentioned above, the operator can freely edit the arrangement of the input interface or adjust any features of the input interface so that the input interface can fit the operator's own requirement. To be noted, the similar operations can be also used to edit the input interface.

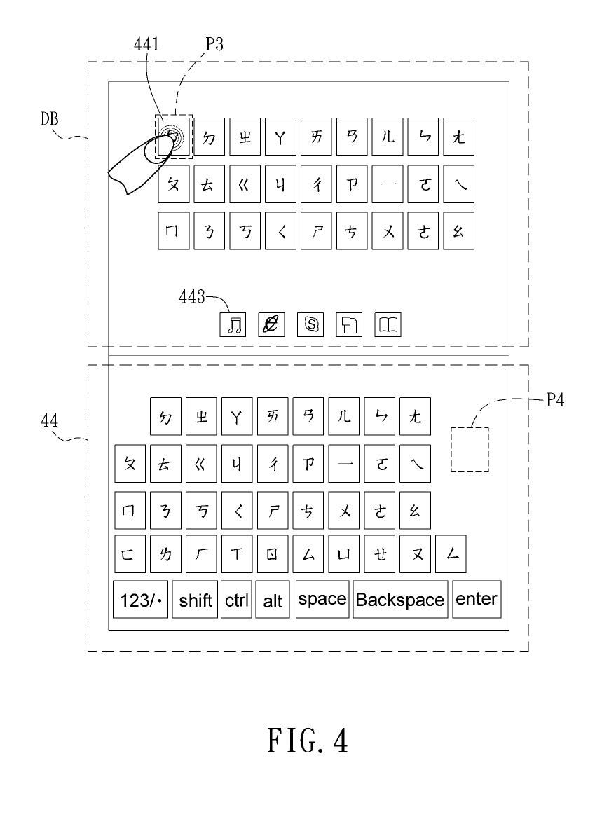

FIG. 4 is a schematic view showing an image displayed by the display module of the electronic apparatus according to a second embodiment of the invention. As shown in FIG. 4, when the input interface is to be edited, the display module of the electronic apparatus can display two parts: a database area DB and an input interface 44. The database area DB includes a plurality of input units that can be added to the input interface 44. In practice, for example, if the operator wants to increase the number of the input units of the input interface 44, the operator can select an input unit 441 displayed at a first position P3 of the database area DB, and then move it to a second position P4 of the input interface 44. Accordingly, one input unit 441 is added to the input interface 44, and the input interface 44 can be set. Because the detailed procedure of the above operation can be known by referring to the first embodiment, it is omitted here. Herein, the input unit 441 originally belongs to the input interface 44, but in other aspect, the input unit added to the input interface is unnecessary to originally belong to the input interface and can have a specific function. For example, the input unit 443 for playing music can be added to the input interface.

On the other hand, if the operator wants to remove the input unit from the input interface, it can be done by the contrary operation. Besides, the size, color, or mark of the input unit can be adjusted before or after the completion of editing the input interface.

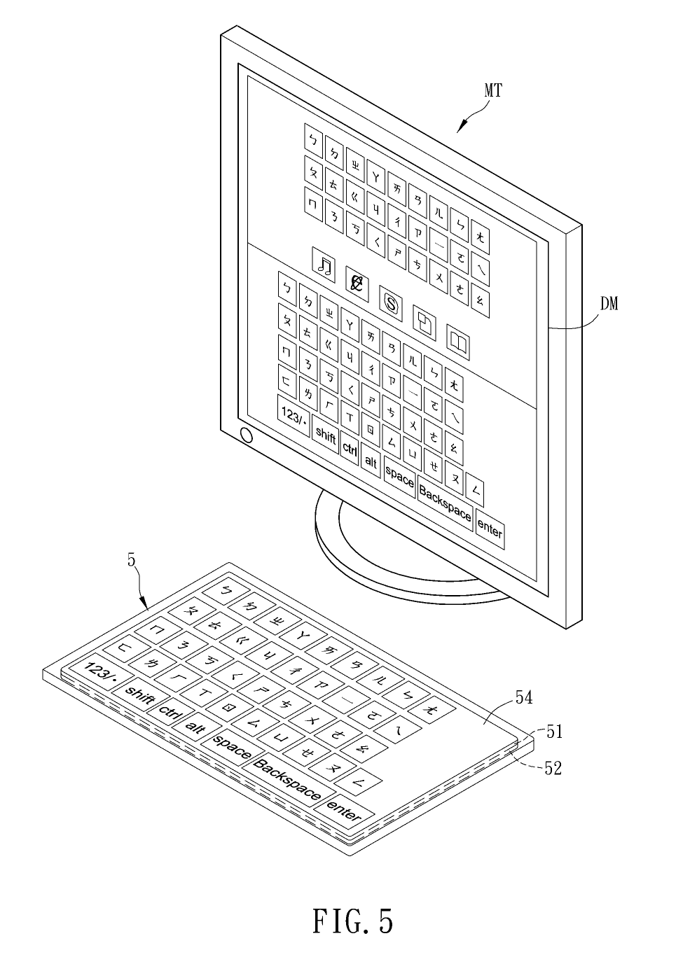

FIG. 5 is a schematic view showing the appearance of the electronic apparatus according to a third embodiment of the invention. In the embodiment, the electronic apparatus 5 can be coupled with, for example, a monitor MT for cooperation. The electronic apparatus 5 is a touch-type keyboard, including a touch module 51 and a display module 52 for displaying an input interface 54. The monitor MT includes another display module DM for displaying the editing process. In detail, once the operator wants to edit the input interface 54, an application program can be performed to show the image (as shown in FIG. 5) displayed on the monitor MT, the image showing a first position of the input unit and a second position to be aimed. Subsequently, the operator can use a mouse, other input devices, or the electronic apparatus 5 to provide the selection event and moving event as mentioned in the first embodiment. Accordingly, the input unit displayed on the display module DM of the monitor MT can be moved between the first and second positions. After the input interface 54 is completely edited and set, it will be displayed simultaneously on the display module 52 of the electronic apparatus 5. Accordingly, the operator can edit the input interface 54 by watching the larger image displayed on the display module DM for more operational convenience. As for the components of the electronic apparatus 5 and the operational procedure, they are similar to the first embodiment, and thus omitted here.

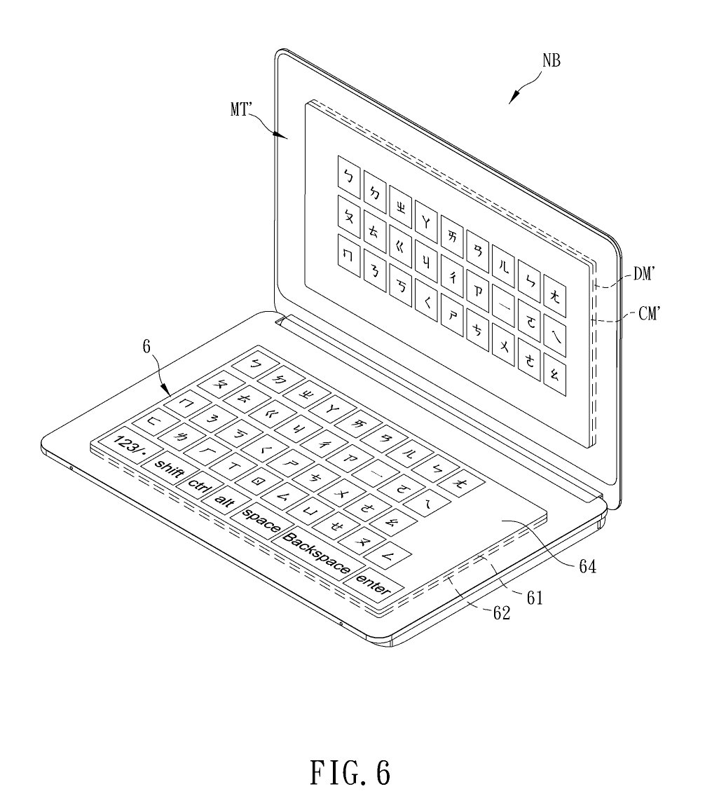

FIG. 6 is a schematic view showing the appearance of the electronic apparatus according a fourth embodiment of the invention. In the embodiment, the electronic apparatus 6 can be, for example, a touch-type keyboard of a notebook NB, and the notebook NB further includes a monitor MT′ which can be cooperated with the electronic apparatus 6. Similar to the third embodiment, the electronic apparatus 6 includes a touch module 61 and a display module 62 which displays an input interface 64. The monitor MT′ includes another touch module CM' and another display module DM′ which displays a database area DB′. The operator can edit the input interface 64 by using the operation similar to the first embodiment, but differently, the arrangement of the input interface 64 is directly edited on the electronic apparatus 6, and the addition or deletion of the input unit is conducted between the monitor MT′ and the electronic apparatus 6. Because the detailed operational procedure in the embodiment can be known by referring to the first embodiment, it is thus omitted here. Of course, all events during the operational process can be provided not only by touching but also by a mouse or other input device. Accordingly, in the embodiment, because the editing of the input interface is not restricted to a single display module, the editing space is enlarged so as to avoid erroneous touches.

In the electronic apparatus according to another embodiment, the display module thereof can display the input units as well as an image data which can be, for example, a stand-by image data, a screen saver data, a desktop data, a photo data, or an audiovisual data. In another embodiment, the input unit that is linked with an image data or an audiovisual data can be selected and freely moved from the database area or other application programs to a specific position displayed on the display module to form an input interface with a specific function.

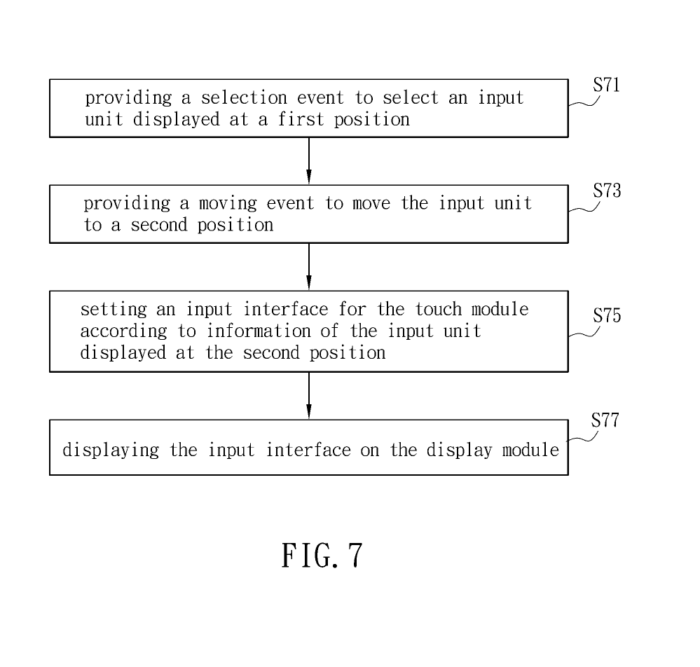

FIG. 7 is a flow chart describing a method, according to a first embodiment of the invention, for editing an input interface. In the embodiment, the method for editing an input interface is applied to an electronic apparatus, and includes steps of: providing a selection event to select an input unit displayed at a first position (S71); providing a moving event to move the input unit to a second position (S73); setting an input interface for the touch module according to information of the input unit displayed at the second position (S75); and displaying the input interface on the display module (S77). The features and operational procedure of the method for editing an input interface and the electronic apparatus of the embodiment are similar to the embodiments as mentioned above, so the detailed description thereof is omitted here.

In summary, for the method for editing an input interface and the electronic apparatus using the same of the invention, the input unit can be freely moved from a first position to a second position, so that the operator can freely edit the arrangement of the input interface to fit the own desires or specific operational requirement. Besides, the first position can be not only on the electronic apparatus, but also on another display module, which also can make the result that the input unit is added to the input interface or removed from the input interface.

According to the method for editing an input interface and the electronic apparatus using the same of the invention, the position of every input unit can be adjusted. The more precious point is that the specific input unit can be added or removed, according to the requirement, by using the unit database. Hence, the seldom used input unit can be replaced by the commonly used one so that the limited space of the input interface can be efficiently utilized. By repeating the operation many times, the selected input units can compose an input interface that fits the operator's habit or requirement and can be stored in the electronic apparatus. Therefore, the invention can achieve the advantage of really customization by operators.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for editing an input interface applied to an electronic apparatus which comprises a display module and a touch module, the method comprising steps of:
providing a selection event to select an input unit displayed at a first position;
providing a moving event to move the input unit to a second position;
setting an input interface for the touch module according to information of the input unit displayed at the second position; and
displaying the input interface on the display module.

2. The method for editing an input interface as recited in claim 1, wherein the first position and the second position are displayed on the display module of the electronic apparatus or on another display module.

3. The method for editing an input interface as recited in claim 1, wherein the first position is displayed on another display module, and the second position is displayed on the display module of the electronic apparatus.

4. The method for editing an input interface as recited in claim 1, wherein the display module is an e-paper, a light-emitting diode (LED) display module, a thin-film transistor (TFT) display module, or a liquid crystal (LC) display module.

5. The method for editing an input interface as recited in claim 1, wherein the touch module is stacked on the display module.

6. The method for editing an input interface as recited in claim 1, wherein the input unit is a key.

7. The method for editing an input interface as recited in claim 1, further comprising a step of:
providing an adjusting event to adjust the input unit.

8. The method for editing an input interface as recited in claim 1, further comprising a step of:
displaying an image data and/or an audiovisual data on the display module of the electronic apparatus.

9. An electronic apparatus, comprising:
a touch module; and
a display module, wherein a selection event is provided to select an input unit displayed at a first position, a moving event is provided to move the input unit to a second position, and an input interface for the touch module is set and displayed on the display module according to information of the input unit displayed at the second position.

10. The electronic apparatus as recited in claim 9, wherein the first position and the second position are displayed on the display module of the electronic apparatus or on another display module.

11. The electronic apparatus as recited in claim 9, wherein the first position is displayed on another display module, and the second position is displayed on the display module of the electronic apparatus.

12. The electronic apparatus as recited in claim 9, wherein the display module is an e-paper, a light-emitting diode (LED) display module, a thin-film transistor (TFT) display module, or a liquid crystal (LC) display module.

13. The electronic apparatus as recited in claim 9, wherein the touch module is stacked on the display module.

14. The electronic apparatus as recited in claim 9, wherein the input unit is a key.

15. The electronic apparatus as recited in claim 9, wherein an adjusting event is provided to adjust the input unit.

16. The electronic apparatus as recited in claim 9, wherein the display module displays an image data and/or an audiovisual data.
